(19) United States
(12) Patent Application Publication
(10) Pub. No.: US 2018/0104715 A1
(43) Pub. Date: Apr. 19, 2018

(54) METHOD AND APPARATUS FOR COATING A THREE-DIMENSIONAL CURVED SUBSTRATE WITH AN ELECTRICAL CONDUCTIVE INK

(71) Applicants: HYUNDAI MOTOR COMPANY, Seoul (KR); Korea Institute of Ceramic Engineering & Technology, Jinju-si (KR)

(72) Inventors: Kyu-Geol Lee, Seongnam-si (KR); Seung Hun Hur, Seoul (KR)

(73) Assignees: HYUNDAI MOTOR COMPANY, Seoul (KR); Korea Institute of Ceramic Engineering & Technology, Jinju-si (KR)

(21) Appl. No.: 15/378,653

(22) Filed: Dec. 14, 2016

(30) Foreign Application Priority Data
Oct. 13, 2016 (KR) 10-2016-0132730

(51) Int. Cl. B05D 1/32; B05D 1/02; B05B 1/04; B05B 15/04; C09D 11/52

(52) U.S. Cl. CPC B05D 1/322; B05D 1/02; C09D 11/52; B05B 15/0406; B05B 1/044

(57) ABSTRACT

A method of coating a three-dimensional curved substrate with electrical conductive ink may include: preparing a curved substrate having a radius of curvature, a patterned curved mask having the same radius of curvature, and a curved slit-type sprayer having the same radius of curvature; covering the curved substrate with the curved mask; spraying a conductive ink toward the curved substrate and the curved mask from the curved slit-type sprayer spaced apart from the curved mask by a predetermined distance; drying the curved substrate and the curved mask; and removing the curved mask from the curved substrate.

### CROSS-REFERENCE TO RELATED APPLICATIONS

This application claims priority to and benefit of Korean Patent Application No. 10-2016-0132730, filed on Oct. 13, 2016, which is incorporated herein by reference in its entirety.

### BACKGROUND

### Field of the Disclosure

The present disclosure relates to a method and apparatus for coating or patterning a three-dimensional substrate or a curved base material with a conductive ink or paste.

### Description of Related Art

Industrially, it is often very important to coat a substrate with a conductive ink or paste. Herein, a conductive ink or paste may mean a conductive ink in which powder is dispersed, a conductive ink in which a binder or the like is mixed, a low viscosity solution, a high viscosity solution, or a paste). For conductive inks, it is also important to then dry the conductive ink in order to generate electric heating. Unlike other coating methods, the uniformity of the coating material for electric heating is very important to the above method. Reliability for coating uniformity must be secured in order to obtain uniform resistance and heating.

Coating methods using conductive ink for electric heating include an inkjet printing method of discharging a conductive ink through a fine nozzle, a screen printing method of applying a high viscosity paste on a patterned silk screen and then coating the screen using a squeezer, a bar coating method of pushing a material to a certain height using a bar, a spray coating method of spraying a low viscosity solution using a spray, and the like.

Most of these coating methods are easily performed on a two-dimensional flat plate. However, the following problems may occur when a three-dimensional base material or a curved or curve-shaped substrate is coated with a conductive ink. One, a problem may occur with being able to uniformly apply the ink per unit area of a curved surface. Two, a problem may occur in which the ink flows down by gravity resulting in a non-uniform thickness being formed due to deflection when the ink has a high viscosity. Three, a problem may occur relating to the removal of residue from a curved patterned mask. More specifically, when the conductive ink has a low viscosity, a severe problem may occur in the flow of the ink to the extent that coating of the base material or substrate is not performed. Accordingly, a separate electric heating pad is typically manufactured and then the heating pad is fused or attached to a curved substrate to be used therefor.

Further, conductive coating films that contain graphene have an advantage of providing electrical conductivity by an electrical conductive mechanism through inter-surface contact due to planer characteristics having an atomic thickness compared to other conductive films (graphite or metal). However, when a three-dimensional curved substrate is coated with an ink having high flowability, the ink may be deflected in the direction of gravity.

### SUMMARY

An embodiment of the present disclosure is directed to forming a conductive film, such as a coating film containing graphene, on a curved substrate having a three-dimensional shape or curved structure. The present disclosure resolves problems relating to (1) uniformly applying a conductive ink onto a curved portion, whereby a non-uniform film thickness affects the uniform film resistance and uniform heating, (2) the applied solution flowing along the curved portion, and (3) the removal of residue from a patterned mask. Such problems are typically caused when a three-dimensional base material or a curved or curve-shaped substrate is coated with the conductive ink. The present disclosure further provides a surface heating element such as a curved heating mirror for a vehicle.

Other objects and advantages of the present disclosure can be understood by the following description, and will become apparent to those having ordinary skill in the art with reference to the embodiments of the present disclosure. Also, those having ordinary skill in the art to which the present disclosure pertains will recognize that the objects and advantages of the present disclosure can be realized by the features, elements, and methods as claimed and combinations thereof

In accordance with one embodiment of the present disclosure, an apparatus for coating a three-dimensional curved substrate with electrical conductive ink includes a curved substrate having a radius of curvature, a curved mask having the same radius of curvature as the curved substrate, the curved mask being patterned to form a pattern on the curved substrate, a curved slit-type sprayer configured such that a cross-section of a nozzle inlet thereof has the same radius of curvature as the curved substrate and the curved mask in order to spray a conductive ink onto the curved mask, and a curved push rod attached to one side of the nozzle inlet of the curved slit-type sprayer so as to push residual conductive ink that remains on the curved mask.

In accordance with another embodiment of the present disclosure, a method of coating a three-dimensional curved substrate with electrical conductive ink includes: preparing a curved substrate having a radius of curvature, a patterned curved mask having the same radius of curvature as the curved substrate, and a curved slit-type sprayer having the radius of curvature as the curved substrate; covering the curved substrate with the curved mask; spraying a conductive ink toward the curved substrate and the curved mask from the curved slit-type sprayer spaced apart from the curved mask by a predetermined distance; drying the curved substrate and the curved mask; and removing the curved mask from the curved substrate.

In accordance with another embodiment of the present disclosure, a method of coating a three-dimensional curved substrate with electrical conductive ink includes: preparing a curved substrate having a radius of curvature, a patterned curved mask having the same radius of curvature as the curved substrate, and a curved slit-type sprayer having the radius of curvature as the curved substrate; covering the curved substrate with the curved mask; spraying a conductive ink toward the curved substrate and the curved mask from the curved slit-type sprayer spaced apart from the curved mask by a predetermined distance; pushing residual conductive ink that remains on the curved mask using a curved push rod having the same radius of curvature so as to remove the residual conductive ink from the curved mask; drying the curved substrate and the curved mask; and removing the curved mask from the curved substrate.

In accordance with a further embodiment of the present disclosure, a method of coating a three-dimensional curved substrate with electrical conductive ink includes: preparing a curved substrate having a radius of curvature, a patterned curved mask having the same radius of curvature as the curved substrate, a curved slit-type sprayer having the radius of curvature as the curved substrate, and a curved push rod attached to one side of a nozzle inlet of the curved slit-type sprayer; covering the curved substrate with the curved mask; spraying a conductive ink toward the curved substrate and the curved mask from the curved slit-type sprayer spaced apart from the curved mask by a predetermined distance; pushing a residual conductive ink that remains on the curved mask from the sprayed conductive ink using the curved push rod attached to one side of the nozzle inlet of the curved slit-type sprayer so as to remove the residual conductive ink from the curved mask; drying the curved substrate and the curved mask; and removing the curved mask from the curved substrate.

### BRIEF DESCRIPTION OF THE DRAWINGS

FIGS. 1(a) and 1(b) are views illustrating a difference between coating methods in a flat substrate and a curved substrate, with FIG. 1(a) illustrating a process in which the flat substrate is coated and FIG. 1(b) illustrating a process in which the curved substrate is coated.

FIG. 2(a) is a view illustrating a structure in which a conductive ink is sprayed on a curved substrate without having a patterned curved mask using a curved slit-type sprayer.

FIG. 2(b) is a view illustrating a structure in which a conductive ink is sprayed on a curved substrate having a patterned curved mask using a curved slit-type sprayer.

FIG. 3(a) is a view illustrating a hard-type curved mask.

FIG. 3(b) is a view illustrating a soft-type curved mask.

FIG. 3(c) is a view illustrating a double film-structured curved mask.

FIG. 4 is a view illustrating a structure in which ink residue is removed from a curved mask using a curved push rod which is separately provided in addition to a curved substrate, a curved slit-type sprayer, and a curved mask, according to the an embodiment of the present disclosure.

FIG. 5 is a view illustrating a structure in which a curved push rod and a curved slit-type sprayer are integrally formed, and the processes of spraying ink and removing ink residue from a curved mask are simultaneously performed by the simultaneous movement of the curved push rod and the curved slit-type sprayer, according to the an embodiment of the present disclosure.

FIG. 6 is a view illustrating a structure in which ink residue is effectively removed from a curved mask using two or multiple curved push rods according to the an embodiment of the present disclosure.

FIG. 7 is a view illustrating a structure in which ink residue is removed from a curved mask using an inclined curved push rod, according to the an embodiment of the present disclosure.

FIG. 8 is a view illustrating a residual ink collection part for collecting a residual conductive ink removed by a curved push rod, and a transfer push rod for moving the conductive ink to a transport part for reuse.

### DESCRIPTION OF SPECIFIC EMBODIMENTS

Embodiments of the present disclosure will be described below in more detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those having ordinary skill in the art. Throughout the disclosure, like reference numerals refer to like parts throughout the various figures and embodiments of the present disclosure.

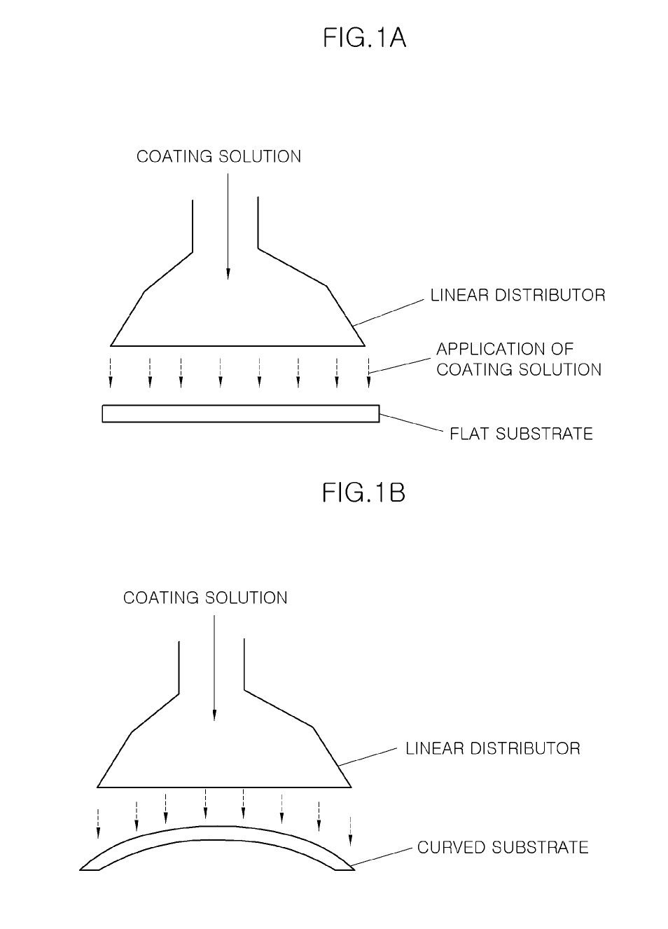

FIGS. 1(a) and 1(b) are views illustrating a difference between coating methods in a flat substrate and a curved substrate. In FIG. 1(a), the coating method may be performed in the flat substrate. In FIG. 1(b), when a three-dimensional base material or a curved or curve-shaped substrate is coated with a conductive ink, there are problems relating to uniformly applying the conductive ink per unit area of a curved surface. These problems relateg to the conductive ink flowing down along the curved surface by gravity, in which case a non-uniform thickness is formed due to deflection when the ink has a high viscosity, and relate to the removal of residue from a curved patterned mask. Further, when the conductive ink has a low viscosity, a severe problem may occur in the flow of the ink to the extent that coating is not performed.

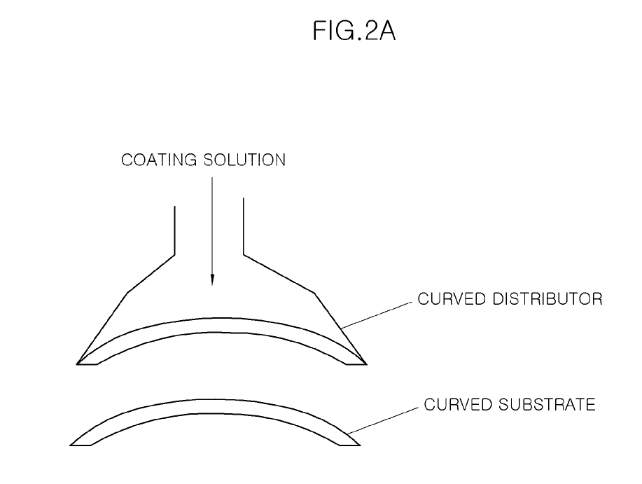

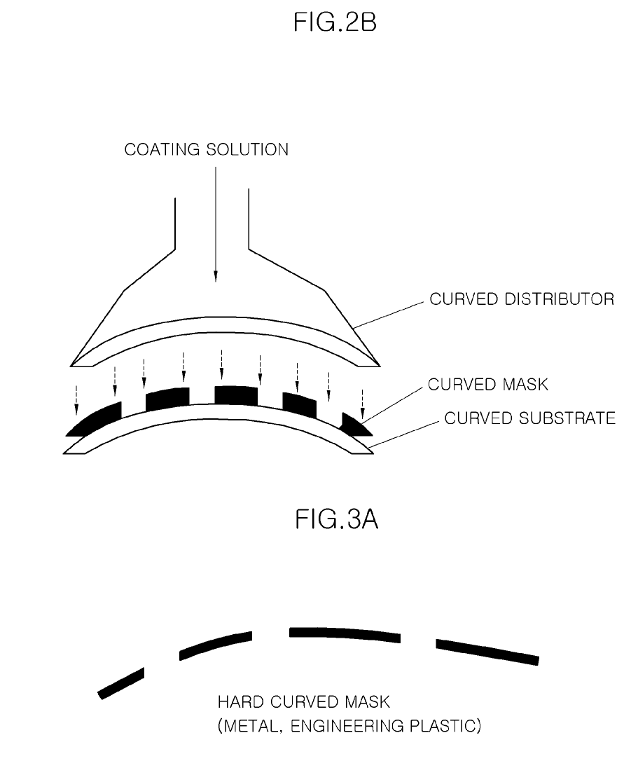

FIG. 2(a) is a view illustrating a structure in which a conductive ink is sprayed on a curved substrate without having a patterned curved mask using a curved slit-type sprayer. FIG. 2(b) is a view illustrating a structure in which a conductive ink is sprayed on a curved substrate having a patterned curved mask using a curved slit-type sprayer. When the patterned curved mask is not formed on the curved substrate, there are problems that relate to uniformly applying the conductive ink per unit area of a curved surface, to the conductive ink flowing down along the curved surface by gravity, in which case a non-uniform thickness is formed due to deflection when the ink has a high viscosity, and to the removal of residue from the curved patterned mask. However, when the patterned curved mask is formed on the curved substrate, the conductive ink may be uniformly applied per unit area of the curved surface, and it is possible to prevent the conductive ink from flowing down along the curved surface by gravity.

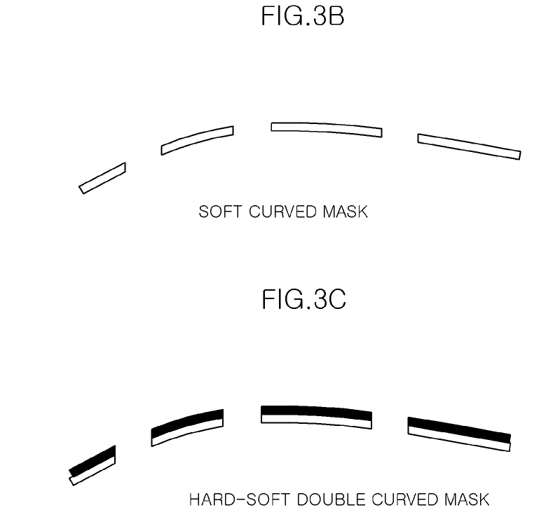

FIG. 3(a) is a view illustrating a hard-type curved mask. FIG. 3(b) is a view illustrating a soft-type curved mask. FIG. 3(c) is a view illustrating a double film-structured curved mask. Since the hard-type curved mask is typically in poor contact with the curved substrate, the conductive ink may leak out of a gap between the curved substrate and the curved mask. On the other hand, in the soft-type curved mask, the leakage of the conductive ink through the gap is prevented. The soft-type curved mask is made of a polymeric material such as rubber or silicon, and the hard-type curved mask is made of a metal or engineered plastic material. In the double film-structured curved mask, the lower layer of the curved mask is made of a metal or engineered plastic material, and the higher or upper layer of the curved mask is made of a polymeric material such as rubber or silicon.

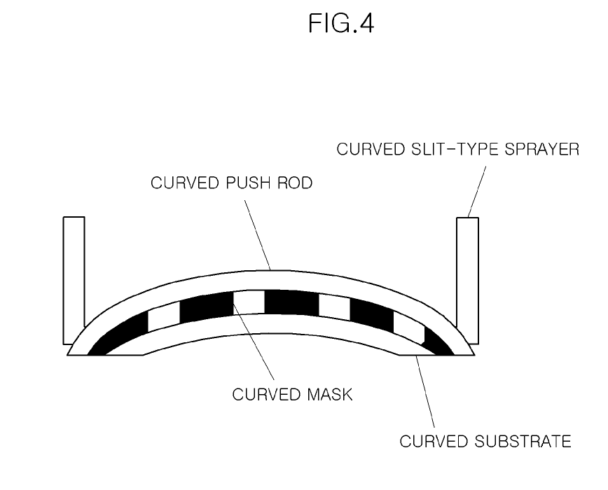

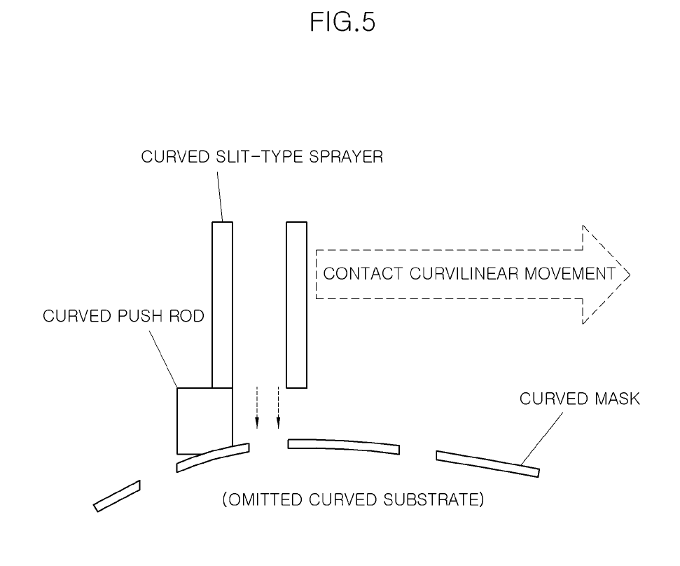

FIG. 4 is a view illustrating a structure in which ink residue is removed from a curved mask using a curved push rod. The curved push rod is separately provided in addition to a curved substrate, a curved slit-type sprayer, and a curved mask, according to an embodiment of the present disclosure.

In FIG. 4, the method of coating a three-dimensional curved substrate with electrical conductive ink according to an embodiment of the present disclosure includes a step of preparing a curved substrate, a patterned curved mask having the same radius of curvature as the curved substrate, and a curved slit-type sprayer having the radius of curvature. The method also includes a step of covering the curved substrate with the curved mask and then a step of spraying a conductive ink toward the curved substrate and the curved mask from the curved slit-type sprayer. The curved slit-type sprayer is spaced apart from the curved mask by a predetermined distance for the spraying step. The method also includes a step of drying the curved substrate and the curved mask and then a step of removing the curved mask from the curved substrate. In this embodiment, a tangent gradient at a position of each of the curved substrate and the curved mask has the same radius of curvature, which is equal to or less than ±5°. This tangent gradient is set considering the viscosity of the conductive ink. If the absolute value of the gradient is greater than ±5°, it is difficult to form a uniform thickness in the pattern due to the flow of the ink by gravity. Meanwhile, the distance between slits in the curved slit-type sprayer is equal to or less than 10 mm. Also, the sprayed conductive ink is dried at a temperature from 50° C. to 200° C.

FIG. 5 is a view illustrating a structure in which a curved push rod and a curved slit-type sprayer are integrally formed. The processes of spraying ink and removing ink residue from a curved mask are simultaneously performed by the simultaneous movement of the curved push rod and the curved slit-type sprayer, according to an embodiment of the present disclosure.

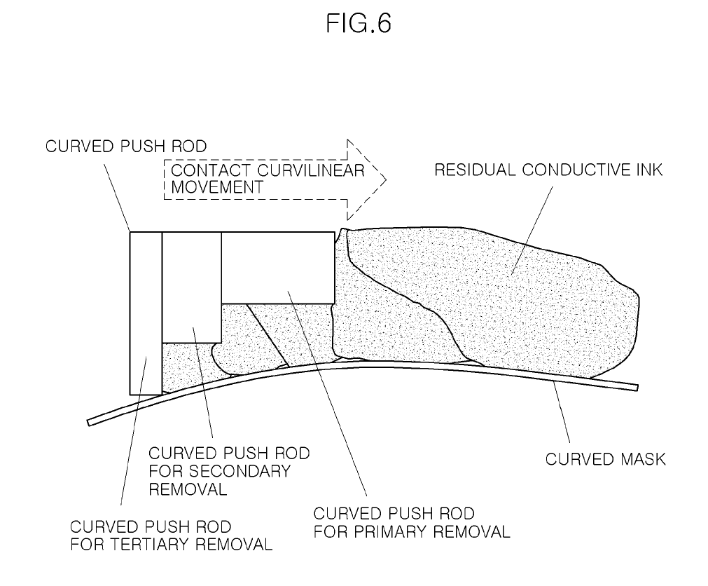

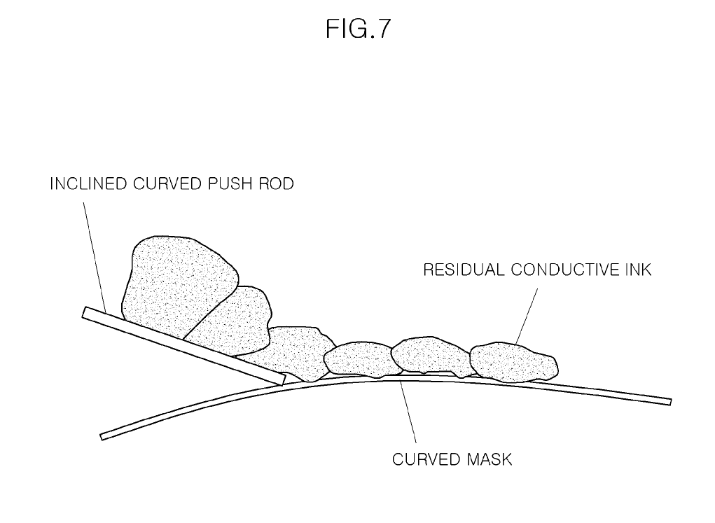

In FIG. 5, the method of coating a three-dimensional curved substrate with electrical conductive ink according to an embodiment of the present disclosure includes a step of preparing a curved substrate, a patterned curved mask having the same radius of curvature as the curved substrate, and a curved slit-type sprayer having the radius of curvature The method also includes a step of covering the curved substrate with the curved mask and then a step of spraying a conductive ink toward the curved substrate and the curved mask from the curved slit-type sprayer. The curved slit-type sprayer is spaced apart from the curved mask by a predetermined distance. The method also includes a step of pushing the conductive ink remaining on the curved mask using a curved push rod having the radius of curvature to remove the residual conductive ink from the curved mask. The method also includes a step of drying the curved substrate and the curved mask and then a step of removing the curved mask from the curved substrate. In this embodiment, the curved push rod is curvilinearly moved along the curved mask in the state in which the curved push rod is in contact with the curved mask. To this end, the lower end surface of the curved push rod is inclined along the curved mask, and the curved push rod may be formed, for example, as multiple columns having different heights. FIG. 6 is a view illustrating a structure in which ink residue is effectively removed from a curved mask using two or multiple curved push rods according to an embodiment of the present disclosure. FIG. 7 is a view illustrating a structure in which ink residue is removed from a curved mask using an inclined curved push rod, according to an embodiment of the present disclosure.

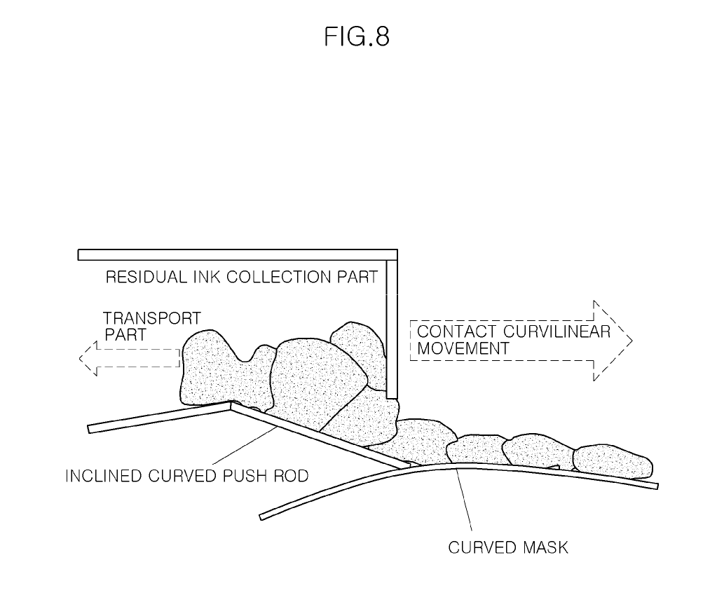

FIG. 8 is a view illustrating a residual ink collection part for collecting residual conductive ink that is removed by a curved push rod, and a transfer push rod for moving the conductive ink to a transport part for reuse of the collected residual conductive ink. In FIG. 8, the method of coating a three-dimensional curved substrate with electrical conductive ink according to an embodiment of the present disclosure includes a step of preparing a curved substrate, a patterned curved mask having the same radius of curvature as the curved substrate, a curved slit-type sprayer having the radius of curvature, and a curved push rod attached to one side of the nozzle inlet of the curved slit-type sprayer. The method also includes a step of covering the curved substrate with the curved mask and then a step of spraying a conductive ink toward the curved substrate and the curved mask from the curved slit-type sprayer. The curved slit-type sprayer is spaced apart from the curved mask by a predetermined distance. The method includes a step of pushing a conductive ink that remains on the curved mask in the sprayed conductive ink using the curved push rod attached to one side of the nozzle inlet of the curved slit-type sprayer to remove the residual conductive ink from the curved mask. The method also includes a step of drying the curved substrate and the curved mask and then a step of removing the curved mask from the curved substrate. The step of removing the residual conductive ink may include a step of pushing the residual conductive ink using the curved push rod so as to move it to a residual ink collection part. The residual conductive ink that is moved to the residual ink collection part may be circulated to a transport part and then may be sprayed again by the curved slit-type sprayer. The residual conductive ink may be transported from the residual ink collection part to the transport part by a transfer push rod extending from the curved push rod. Further, the curved push rod is curvilinearly moved in such a manner that the curved push rod is inclined and forms an obtuse angle with the surface of the curved mask on which the residual conductive ink is pushed.

For performing such a method, the apparatus for coating a three-dimensional curved substrate with electrical conductive ink according to an embodiment of the present disclosure includes a curved substrate and a curved mask having the same radius of curvature as the curved substrate. The curved mask is patterned to form a pattern on the curved substrate. A curved slit-type sprayer is configured such that the cross-section of the nozzle inlet thereof has the same radius of curvature as the curved substrate and the curved mask in order to spray a conductive ink to the curved mask. A curved push rod is attached to one side of the nozzle inlet of the curved slit-type sprayer so as to push the conductive ink remaining on the curved mask. In this case, a residual ink collection part for collecting the residual conductive ink pushed by the curved push rod may be located between the nozzle inlet of the curved slit-type sprayer and the curved push rod. The residual conductive ink that is moved to the residual ink collection part may be circulated to a transport part and may then be sprayed again by the curved slit-type sprayer. The residual ink collection part may be provided with a transfer push rod that extends from the curved push rod. The residual conductive ink may be transported to the transport part by the transfer push rod.

While the present disclosure has been described with respect to the specific embodiments, it will be apparent to those skilled in the art that various changes and modifications may be made without departing from the spirit and scope of the disclosure as defined in the following claims.

What is claimed is:

1. A method of coating a three-dimensional curved substrate with electrical conductive ink, the method comprising:
preparing a curved substrate having a radius of curvature, a patterned curved mask having the radius of curvature of the curved substrate, and a curved slit-type sprayer having the radius of curvature of the curved substrate;
covering the curved substrate with the curved mask;
spraying a conductive ink toward the curved substrate and the curved mask from the curved slit-type sprayer spaced apart from the curved mask by a predetermined distance;
drying the curved substrate and the curved mask; and
removing the curved mask from the curved substrate.

2. The method of claim 1, wherein the step of preparing includes the curved mask being made of a soft polymeric material such as rubber or silicon.

3. The method of claim 1, wherein the step of preparing includes the curved mask having a double film structure, a lower layer of the curved mask being made of a metal or engineered plastic material, and a higher layer of the curved mask being made of a polymeric material such as rubber or silicon.

4. The method of claim 1, wherein the step of preparing includes a tangent gradient at a position of each of the curved substrate and the curved mask having the radius of curvature is equal to or less than ±5°.

5. The method of claim 1, wherein the step of spraying includes a distance between slits in the curved slit-type sprayer being equal to or less than 10 mm.

6. The method of claim 1, wherein the step of drying includes the sprayed conductive ink being dried at a temperature from 50° C. to 200° C.

7. A method of coating a three-dimensional curved substrate with electrical conductive ink, the method comprising:
preparing a curved substrate having a radius of curvature, a patterned curved mask having the radius of curvature of the curved substrate, and a curved slit-type sprayer having the radius of curvature of the curved substrate;
covering the curved substrate with the curved mask;
spraying a conductive ink toward the curved substrate and the curved mask from the curved slit-type sprayer spaced apart from the curved mask by a predetermined distance;
pushing residual conductive ink that remains on the curved mask using a curved push rod having the radius of curvature so as to remove the residual conductive ink from the curved mask;
drying the curved substrate and the curved mask; and
removing the curved mask from the curved substrate.

8. The method of claim 7, wherein the step of preparing includes a tangent gradient at a position of each of the curved substrate and the curved mask having the radius of curvature being equal to or less than ±5°.

9. The method of claim 7, wherein the step of preparing includes the curved mask being made of a soft polymeric material such as rubber or silicon.

10. The method of claim 7, wherein the step of preparing includes the curved mask having a double film structure, a lower layer of the curved mask being made of a metal or engineered plastic material, and a higher layer of the curved mask being made of a polymeric material such as rubber or silicon.

11. The method of claim 7, wherein the step of pushing includes the curved push rod being curvilinearly moved along the curved mask in a state in which the curved push rod is in contact with the curved mask.

12. The method of claim 11, wherein, in the step of pushing, in order for the curved push rod to be curvilinearly moved, the curved push rod has a lower end surface inclined along the curved mask.

13. The method of claim 12, wherein the step of pushing includes the curved push rod being formed as multiple columns having different heights.

14. A method of coating a three-dimensional curved substrate with electrical conductive ink, the method comprising:
preparing a curved substrate having a radius of curvature, a patterned curved mask having the radius of curvature of the curved substrate, a curved slit-type sprayer having the radius of curvature of the curved substrate, and a curved push rod attached to one side of a nozzle inlet of the curved slit-type sprayer;
covering the curved substrate with the curved mask;
spraying a conductive ink toward the curved substrate and the curved mask from the curved slit-type sprayer spaced apart from the curved mask by a predetermined distance;
pushing a residual conductive ink that remains on the curved mask in the sprayed conductive ink using the curved push rod attached to one side of the nozzle inlet of the curved slit-type sprayer so as to remove the residual conductive ink from the curved mask;
drying the curved substrate and the curved mask; and
removing the curved mask from the curved substrate.

15. The method of claim 14, wherein the step of pushing includes pushing the residual conductive ink using the curved push rod so as to move the residual conductive ink to a residual ink collection part.

16. The method of claim 15, wherein the step of pushing includes the residual conductive ink moved to the residual ink collection part being circulated to a transport part and being sprayed again by the curved slit-type sprayer.

17. The method of claim 16, wherein the step of pushing includes the curved push rod being curvilinearly moved in such a manner that the curved push rod is inclined and forms an obtuse angle with a surface of the curved mask on which the residual conductive ink is pushed.

18. The method of claim 17, wherein the step of pushing includes the residual conductive ink being transported from the residual ink collection part to the transport part by a transfer push rod extending from the curved push rod.

19. The method of claim 18, wherein the step of pushing includes the transfer push rod being inclined in a direction opposite to an inclined surface of the curved push rod so as to be directed toward the transport part.

20. An apparatus for coating a three-dimensional curved substrate with electrical conductive ink, the apparatus comprising:
a curved substrate having a radius of curvature;
a curved mask having the radius of curvature of the curved substrate, the curved mask being patterned to form a pattern on the curved substrate;
a curved slit-type sprayer configured such that a cross-section of a nozzle inlet thereof has the radius of curvature of the curved substrate and the curved mask in order to spray a conductive ink to the curved mask; and
a curved push rod attached to one side of the nozzle inlet of the curved slit-type sprayer so as to push a residual conductive ink that remains on the curved mask.

21. The apparatus of claim 20, further comprising:
a residual ink collection part for collecting the residual conductive ink that is pushed by the curved push rod, the residual ink collection part being located between the nozzle inlet of the curved slit-type sprayer and the curved push rod.

22. The apparatus of claim 21, wherein the residual conductive ink that is moved to the residual ink collection part is circulated to a transport part and to be sprayed again by the curved slit-type sprayer.

23. The apparatus of claim 22, further comprising:
a transfer push rod that transports the residual conductive ink from the residual ink collection part to the transport part, the transfer push rod extending from the curved push rod.
